(19) United States
(12) Patent Application Publication
(10) Pub. No.: US 2005/0103004 A1
(43) Pub. Date: May 19, 2005

(54) Velocity intensifying power system

(76) Inventor: Esper John Heigle, Ft. Myers, FL (US)

Correspondence Address: Esper John Heigle, P.O. Box 6523, Ft. Myers, FL, 33911, US

(21) Appl. No.: 10/715,191

(22) Filed: Nov. 18, 2003

(51) Int. Cl. F16D 31/00

(52) U.S. Cl. 60/325

(57) ABSTRACT

The disclosure includes a velocity intensifying system including a fluid medium that is circulating within an enclosed main fluid course. The main fluid course consists of a tubular structure having a predetermined diameter. The fluid medium is circulated by a bi-pass tubular arrangement having a pump therein. The pump has an inlet tube connected to the main course that has a diameter size less than the diameter size of the main course. The outlet tube from the pump has a diameter size that is less than the inlet tube to the pump. The outlet tube from the pump drives a helix which is located within the main course of the system which contains the water. The helix drives a shaft of a generator which is located on the exterior of the main course. The ever decreasing sizes of the tubes leading from one end of the main circuit to another, the volume of fluid within the system will drive subsequent elements at increasing speeds to thereby obtain a more energy output than an energy initially required.

### CROSS REFERENCE TO RELATED APPLICATION

(none)

### STATEMENT REGARDING FED SPONSORED R&D

(none)

### BACKGROUND OF THE INVENTION

The “Velocity Intensifying Power System” demonstrates the capability of significantly increasing the usable fluid flow. The inventive device will significantly increase energy output without increasing the energy input. This is a free energy system that has been sought for hundreds of years. The inventive system is a supercharger with very few moving parts and will move any fluid at sub-sonic speed without an increase in energy input.

### SUMMARY OF THE INVENTION

The system consists of a sealed water course wherein water is circulated at increasing speeds. Any other fluid medium may be used. The increasing speeds from one stage to another, are utilized to produce higher speeds of subsequent generators externally of the water course to drive a generator at higher speeds when compared to the initial speed of the pump and the energy of electric motor driving the pump.

### BRIEF DESCRIPTION OF THE DRAWING

FIG. 1 illustrates a perspective view of the main water course and the components thereof.

### DETAILED DESCRIPTION OF THE INVENTION

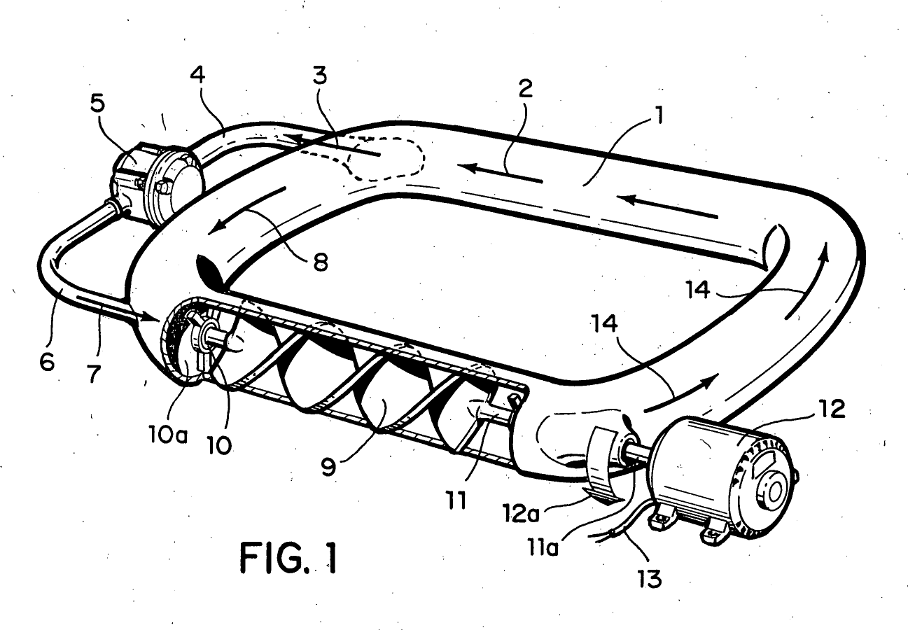

FIG. 1 illustrates the overall system wherein the main water course tube 1 is shown in a perspective view and the tube being sealed to the outside environment once it is filled with a fluid, such as water. The water course tube is the largest size diameter tube in the system such as, for example, six inches. The water course tube 1 is also made of an oblong structure presenting two long and straight sides and two short sides. The arrow 2 represents the direction of the water flow once it is started. One of the short sides of the water tube has a water bi-pass 3 therein into the tube 4. The water flow is instigated by the pump 5 through the tube 6 and thereafter is delivered under a speed increase and lower internal water pressure into a water delivery tube 6 in the direction of arrow 7 and thereafter into the open center 10a of the water course tube 1. The phenomena of the water speed increasing and the water pressure dropping is well known as the “Bernoulli Equation”. It should be noted at this time that the water inlet tube 4 should be about 2 inches in diameter and about 1½ inch diameter from the pump 5 outlet tube 6 into the main watercourse tube 6. Therefore, there is an increase in speed and pressure of the water from the larger diameter tube 1 to the smaller diameter tube 4 as the pump pressurizes the water and there is a further decrease in pressure by about 71% in the water pressure when compared to the water speed as the pump delivers the water into a further smaller diameter tube 6. From the smaller tube 6, the water with increased speed enters the main tube 1 at 10a to thereby entrain the water flowing in the main tube 1 and keep the water circulating within the main tube 1. This last speed increase and lowered pressure of the water impacts on a helix screw 9 which is supported for rotation at one end by a bearing 10 in an open center support 10a. The helix screw may take different shapes and structures. For example, the helix may have any pitch that is desired or it may take more or less convolutions. On the other end of the helix 9 there is a shaft 11 which exits the main tube 1 at 11a which will rotate in the direction of arrow 12a. The water in the main tube 1 continues to flow in the direction of the arrows 14 to recirculate the water in the main tube in the direction of the arrow 2 to resume its normal flow and back into the tube 3 and further into the into the tube again. The shaft 11a of the rotating helix 9 and on the outside of the main tube 1 drives the shaft 11a of a generator motor 12 having the delivery electricity line 13 thereon.

It can now be seen that the ever increasing volume and speed of the water throughout the system creates a much higher rotation within the generator 12 when compared to the speed and pressure of the pump 5. This then, results in a higher electric energy output at 13 when compared to the electric energy input of the pump 5 at the beginning of the cycle.

1. Velocity intensifying power system including a main circuit in the form of a tube having a fluid medium therein, said tube circuit being shaped in an oblong structure, a pump is located on an outside of said main circuit and drawing fluid from an inside of said main circuit by way of a bi-pass tube, said bi-pass having an inlet tube feeding fluid into said pump and an outlet tube from said pump and feeding fluid into said main tube, said outlet tube driving a helix in a rotation, said helix having an outlet shaft driving a shaft of a generator located on an exterior of said main circuit.

2. The velocity intensifying power system of claim 1 including different pitches of said helix

3. The velocity intensifying power system of claim 1, wherein said main circuit tube has a predetermined diameter, and wherein said inlet tube to said pump has a diameter which is less in size than said main tube diameter and wherein said outlet tube from said pump has a diameter which is less in size than said inlet tube into said pump.

4. The velocity intensifying power system of claim 2, wherein there is a velocity increase of the fluid medium from said main fluid course into said input of said pump and wherein there is another velocity increase and a fluid pressure decrease in said fluid medium after said fluid medium exits from said pump to thereby drive said helix and said generator at a higher rate than said pump to produce a higher energy output at said generator than the energy requirement to drive said pump.
